(19) United States
(12) Patent Application Publication
(10) Pub. No.: US 2015/0059159 A1
(43) Pub. Date: Mar. 5, 2015

(54) APPARATUS FOR MANUFACTURING A SEMICONDUCTOR DEVICE AND METHOD OF MANUFACTURING A SEMICONDUCTOR DEVICE

(71) Applicant: Taiwan Semiconductor Manufacturing Company Ltd., Hsinchu (TW)

(72) Inventors: KUAN-LIN HO, HSINCHU CITY (TW); CHIN-LIANG CHEN, KAOHSIUNG CITY (TW); WEI-TING LIN, TAIPEI CITY (TW); YU-CHIH LIU, TAIPEI CITY (TW); SHIH-YEN LIN, NEW TAIPEI CITY (TW)

(73) Assignee: TAIWAN SEMICONDUCTOR MANUFACTURING COMPANY LTD., HSINCHU (TW)

(21) Appl. No.: 14/013,971

(22) Filed: Aug. 29, 2013

(51) Int. Cl. B25H 1/02

(52) U.S. Cl. CPC B25H 1/02
USPC 29/559; 269/296

(57) ABSTRACT

An apparatus for manufacturing a semiconductor device includes a holder for holding a carrier and a supporting base for receiving the holder comprising a recess for accommodating a plurality of balls mounted on a surface of the carrier. Furthermore, a method of manufacturing a semiconductor device includes providing a carrier, providing an apparatus comprising a supporting base including a recess, holding the carrier on the supporting base and accommodating a plurality of balls mounted on a surface of the carrier in the recess.

### FIELD

The disclosure relates to an apparatus for manufacturing a semiconductor device and a method of manufacturing a semiconductor device.

### BACKGROUND

Electronic equipments involving semiconductor devices are indispensable from our daily life. With the advancement of electronic technology, electronic equipments become smaller and smaller in size, and thus semiconductor devices inside the electronic equipments are also getting smaller, thinner and lighter. Thus, flip chip packing (FCP) and wafer level packaging (WLP) technology have been gaining in popularity and is widely applied. This technology provides a wafer level manufacturing of the semiconductor devices with high functions and performances while the size of the semiconductor devices is minimized.

FCP and WLP technology are widely adopted for assembling and combining a number of semiconductor components to become a semiconductor package as a chip scale package (CSP) so as to minimize the final size of the semiconductor device as well as the electronic equipment. During the operations of assembling the semiconductor package, the semiconductor package is stored and transported from an operation to a subsequent operation by a supporter such as a tray, a boat, a rack or a magazine etc. However, the semiconductor package includes many semiconductor components with complicated structure and involves many complicated manufacturing operations. The semiconductor package is easily damaged during transportation and transition between operations.

As a complexity of the manufacturing operations and the configuration of the CSP are increased, there are more challenges to a yield of manufacturing and a simplification of operations. As such, there is a continuous need to improve the method for processing the CSP and solve the above deficiencies.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of an apparatus including a holder and a supporting base in accordance with some embodiments of the present disclosure.

FIG. 2 is a schematic view of a holder including a through hole in accordance with some embodiments of the present disclosure.

FIG. 2A is a schematic view of a holder in a polygonal shape in accordance with some embodiments of the present disclosure.

FIG. 2B is a schematic view of a holder in a circular shape in accordance with some embodiments of the present disclosure.

FIG. 3 is a schematic view of a supporting base including a recess in accordance with some embodiments of the present disclosure.

FIG. 3A is a schematic view of a supporting base in a polygonal shape in accordance with some embodiments of the present disclosure.

FIG. 3B is a schematic view of a supporting base in a circular shape in accordance with some embodiments of the present disclosure.

FIG. 4 is a schematic view of a carrier including a number of balls in accordance with some embodiments of the present disclosure.

FIG. 5A is a schematic view of a holder including a slit in accordance with some embodiments of the present disclosure.

FIG. 5B is a schematic view of a holder including a slot in accordance with some embodiments of the present disclosure.

FIG. 6A is a schematic view of a holder including a first clipping member and a second clipping member in accordance with some embodiments of the present disclosure.

FIG. 6B is an exploded view of a holder including a first clipping member and a second clipping member and a carrier disposed between the first clipping member and the second clipping member in accordance with some embodiments of the present disclosure.

FIG. 6C is a schematic view of a holder including a first clipping member and a second clipping member coupled by a first interconnection structure in accordance with some embodiments of the present disclosure.

FIG. 6D is a schematic view of an apparatus including a holder coupled with a supporting base by a second interconnection structure in accordance with some embodiments of the present disclosure.

FIG. 7A is a schematic view of a holder in a mesh configuration in accordance with some embodiments of the present disclosure.

FIG. 7B is a schematic view of a holder in a mesh configuration with a number of slots in accordance with some embodiments of the present disclosure.

FIG. 8 is a schematic view of an apparatus including a supporting base and an elongated piece of a holder in accordance with some embodiments of the present disclosure.

FIG. 9 is a schematic view of a supporting base in a mesh configuration with a number of recesses in accordance with some embodiments of the present disclosure.

FIG. 10 is a schematic view of an apparatus including a third interconnection structure for coupling an elongated piece of a holder with a supporting base in accordance with some embodiments of the present disclosure.

FIG. 11 is a flow diagram of a method of manufacturing a semiconductor device in accordance with some embodiments of the present disclosure.

FIG. 11A is a schematic view of provision of a carrier in accordance with some embodiments of the present disclosure.

FIG. 11B is a schematic view of bonding a die on a carrier in accordance with some embodiments of the present disclosure.

FIG. 11C is a schematic view of molding a die and a carrier in accordance with some embodiments of the present disclosure.

FIG. 11D is a schematic view of mounting a number of solder balls on a carrier in accordance with some embodiments of the present disclosure.

FIG. 11E is a schematic view of provision of an apparatus in accordance with some embodiments of the present disclosure.

FIG. 11F is a schematic view of holding a carrier by an apparatus in accordance with some embodiments of the present disclosure.

FIG. 11G is a schematic view of accommodating a number of solder balls by a supporting base in accordance with some embodiments of the present disclosure.

FIG. 11H is a schematic view of disposing a heat sink over a carrier in accordance with some embodiments of the present disclosure.

### DETAILED DESCRIPTION OF THE INVENTION

A semiconductor package is manufactured by a number of operations. During the manufacturing of the semiconductor package such as flip chip chip scale package (FCCSP), a flip chip die is bonded on a wafer substrate held by a boat. A number of solder bumps pads on the wafer substrate are bonded with a number of flip chip solder bumps on a bottom surface of the flip chip die. The flip chip solder bumps are then reflowed by a heat treatment. Underfill and molding compound including an electrically non-conductive material are applied to fill space between the flip chip die and the flip chip solder bumps in order to protect the flip chip solder bumps from cracking. The flip chip die is then individualized from the wafer substrate by singulation.

Each of the flip chip die is transferred from the tray to a boat for a subsequent operations of heat sink attachment and ball mounting, and the solder balls have to be heat treated by reflow. The FCCSP is then transferred from the boat back to the tray for packing and dispatching. However, such manufacturing operations involve many transitions of the wafer substrate between different supporters, for example tray to boat or boat to tray.

Furthermore, the heat sink has to be attached on the die and the underfill and molding compound have to be used for heat sink attachment even the die is damaged or without die before the operations of heat sink attachment. This leads to materials wastage issue.

The manufacturing and use of the embodiments are discussed in details as below. It should be appreciated, however, that the embodiments provide many applicable inventive concepts that can be embodied in a wide variety of specific contexts. It is to be understood that the following disclosure provides many different embodiments or examples for implementing different features of various embodiments. Specific examples of components and arrangements are described below to simplify the present disclosure. These are, of course, merely examples and are not intended to be limiting.

Embodiments, or examples, illustrated in the drawings are disclosed below using specific language. It will nevertheless be understood that the embodiments and examples are not intended to be limiting. Any alterations and modifications in the disclosed embodiments, and any further applications of the principles disclosed in this document are contemplated as would normally occur to one of ordinary skill in the pertinent art.

Further, it is understood that several processing steps and/or features of a device may be only briefly described. Also, additional processing steps and/or features can be added, and certain of the following processing steps and/or features can be removed or changed while still implementing the claims. Thus, the following description should be understood to represent examples only, and are not intended to suggest that one or more steps or features is required.

In addition, the present disclosure may repeat reference numerals and/or letters in the various examples. This repetition is for the purpose of simplicity and clarity and does not in itself dictate a relationship between the various embodiments and/or configurations discussed.

In the present disclosure, a semiconductor package manufactured by an apparatus and a method of manufacturing the semiconductor package for simplifying the manufacturing operations and reducing the manufacturing cost are disclosed. The apparatus is configured for holding the semiconductor package so as to facilitate certain manufacturing operations and thus improve an operation throughput. Furthermore, the method of manufacturing the semiconductor package has simplified the manufacturing operations, reduced a material and manufacturing cost, lower yield loss and less risk of damages of the semiconductor package.

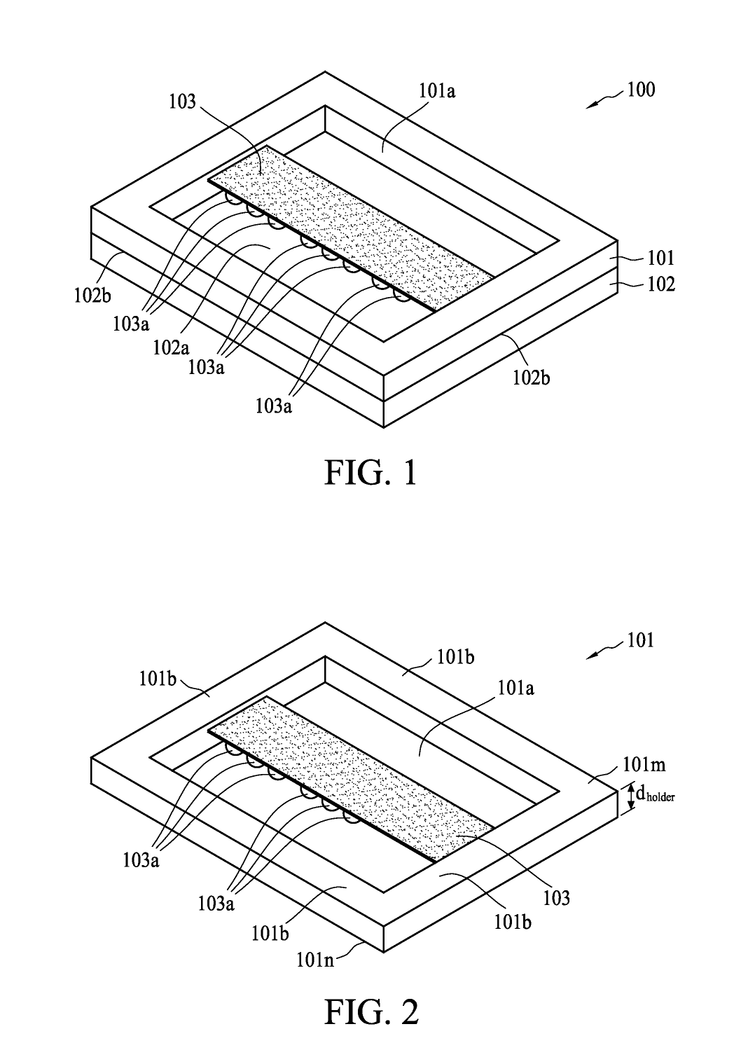

FIG. 1 is an embodiment of an apparatus 100. The apparatus 100 for manufacturing a semiconductor package includes a holder 101 for holding a carrier 103 and a supporting base 102 for receiving the holder 101. The holder 101 is disposed on top of the supporting base 102. The holder 101 is supported on the supporting base 102 by a periphery 102b of the supporting base 102. The holder 101 covers and stacks on the supporting base 102. In some embodiments, the holder 101 includes a through hole 101a for receiving the carrier 103. In some embodiments, the holder 101 has a similar profile and dimension as the supporting base 102. For example, both the holder 101 and the supporting base 102 are configured in rectangular shape with similar size as in FIG. 1. In some embodiments, the holder 101 and the supporting base 102 respectively include a metal such as aluminum or etc.

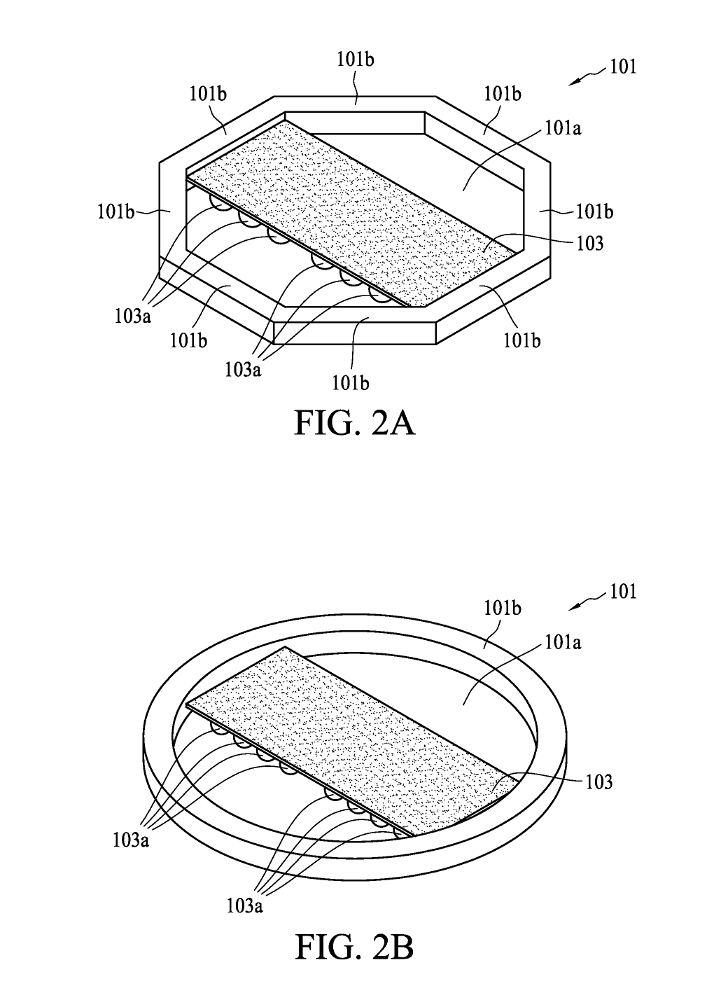

In some embodiments, the holder 101 is in a frame shape as in FIG. 2. The holder 101 includes one or more strips 101b and a through hole 101a. The strips 101b and the through hole 101a are configured to be a closed loop for holding the carrier 103. The through hole 101a is surrounded by the strips 101b. The through hole 101a is defined by extending from a top surface 101m through a bottom surface 101n of the holder 101 along a depth d_{holder} of the holder 101. The through hole 101a is configured to have a dimension so that a substantial area of the carrier 103 is housed within the through hole 101a as in FIG. 2.

In some embodiments, the holder 101 includes four strips 101b in a rectangular frame shape as in FIG. 2, or includes numbers of strips 101b in a polygonal frame shape as in FIG. 2A, or includes a continuous strip 101b in a circular frame shape as in FIG. 2B, or etc. In some embodiments, the shape of the holder 101 is substantially the same as a shape of the through hole 101a. For example, the holder 101 and the through hole 101a are in a quadrilateral shape as in FIG. 2, or the holder 101 and the through hole 101a are in a polygonal shape as in FIG. 2A, or the holder 101 and the through hole 101a are in a circular shape as in FIG. 2B, etc. Other shapes of the strips 101b are within the contemplated scope of the present disclosure.

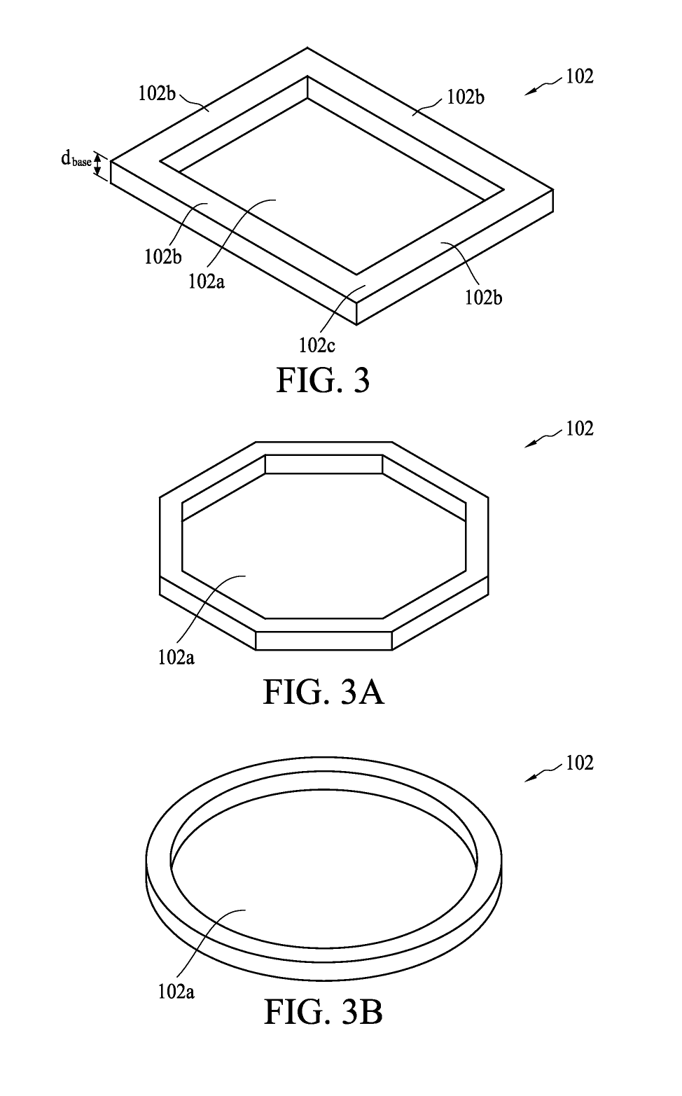

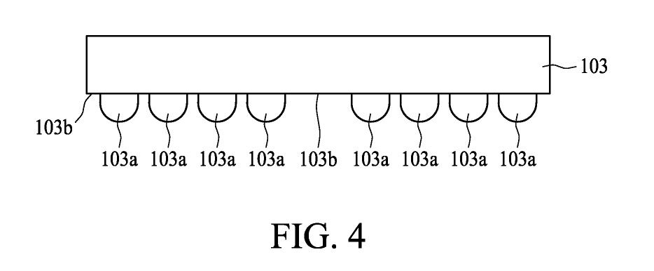

In some embodiments, the supporting base 102 includes a recess 102a as in FIG. 3. The recess 102a is configured for accommodating a number of balls 103a mounted on a surface 103b of the carrier 103 as in FIG. 4. In some embodiment, the carrier 103 is in a strip shape. The recess 102a is a cavity surrounded by a periphery 102b of the supporting base 102. The recess 102a is extended from a top surface 102c of the supporting base 102 along a depth d_{base} of the supporting base 102. In some embodiments, the supporting base 102 is in various shapes. The recess 102a and the periphery 102b of the supporting base 102 are in a quadrilateral shape as in FIG. 3, or in a polygonal shape as in FIG. 3A, or in a circular shape as in FIG. 3B, or etc.

In some embodiments, a holder is in similar profile and dimension as a supporting base. The shape and dimension of the holder and the supporting base are matched and cooperated with each other in order to stack the holder on the supporting base. In some embodiments, the quadrilateral holder 101 as in FIG. 2 stacks and covers on the quadrilateral supporting base 102 as in FIG. 3, or the polygonal holder 101 as in FIG. 2A stacks and covers on the polygonal supporting base 102 as in FIG. 3A, or the circular holder 101 as in FIG. 2B stacks and covers on the circular supporting base 102 as in FIG. 3B, or etc.

In some embodiments, a through hole of a holder is in similar profile and dimension as a recess of a supporting base. The recess is substantially overlapped with the through hole of the holder. The shape and dimension of the through hole and the recess are matched with each other, so that a carrier is housed within the through hole and balls on the carrier 103 are passed through the through hole and accommodated by the recess. In some embodiments, the quadrilateral through hole 101a as in FIG. 2 overlaps with the quadrilateral recess 102a as in FIG. 3, or the polygonal through hole 101a as in FIG. 2A overlaps with the polygonal recess 102a as in FIG. 3A, or the circular through hole 101a as in FIG. 2B overlaps with the circular recess 102a as in FIG. 3B, or etc.

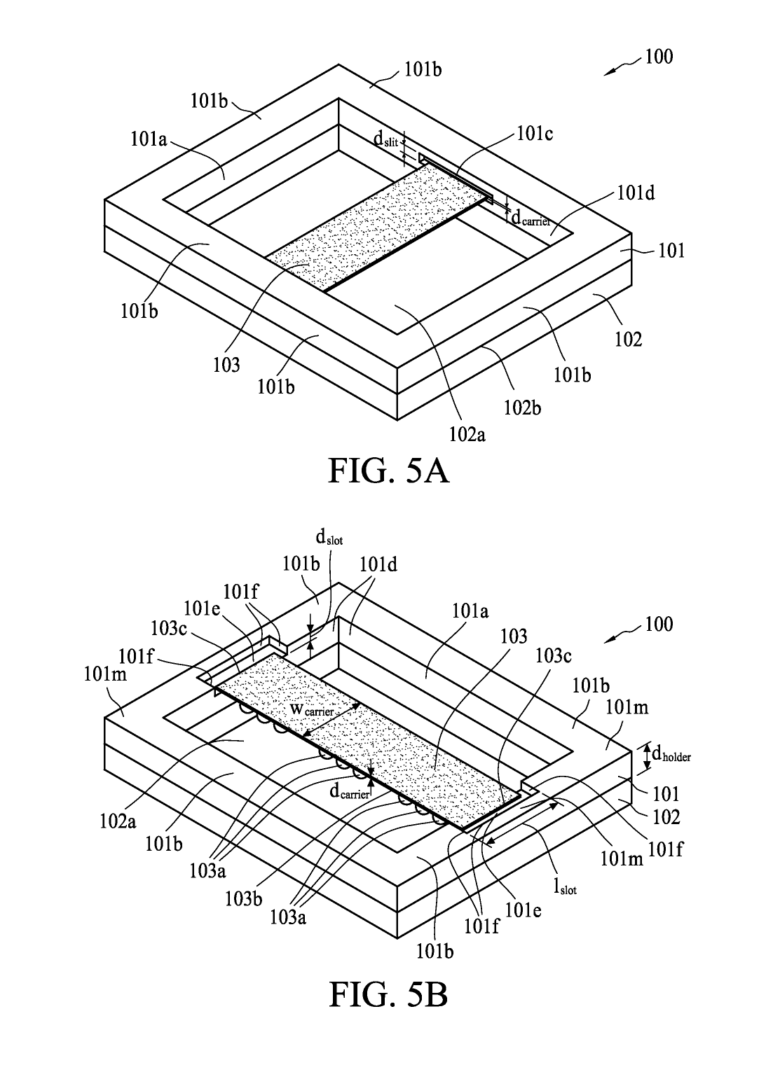

FIG. 5A is an embodiment of a holder 101 which holds a carrier 103 by a slit 101c on a strip 101b. The slit 101c is disposed on a surface of the strip 101b. In some embodiments, the surface is a sidewall 101d of a through hole 101a. The slit 101c is configured for receiving and housing a periphery 103c of the carrier 103. The periphery 103c of the carrier 103 inserts into the slit 101c to hold the carrier 103. In some embodiments, the carrier 103 is snapped into the slit 101c and thus securely held within the slit 101c. The slit 101c is configured in an elongated quadrilateral shape on the sidewall 101d of the through hole 101a as in FIG. 5A. In some embodiments, the slit 101c is shaped and sized in accordance with a thickness d_{carrier} of the carrier 103. In some embodiments, a depth dₛₗᵢₜ of the slit 101c is substantially the same as the thickness d_{carrier} of the carrier 103.

FIG. 5B is an embodiment of a holder 101 which holds a carrier 103 by a slot 101e on a strip 101b. The slot 101e is indented from a top surface 101m of the holder 101. The slot 101e is configured for receiving a periphery 103c of the carrier 103. The carrier 103 is disposed within and held by the slot 101e. The slot 101e is extended from the top surface 101m of the holder 101 along a depth d_{holder} of the holder 101. In some embodiments, the slot 101e is configured in an elongated quadrilateral shape with three sidewalls 101f, so that the carrier 103 passes into the slot 101e from a side of the slot 101e and is held within the slot 101e. In some embodiments, the slot 101e is shaped and sized in accordance with a thickness d_{carrier} of the carrier 103. In some embodiments, a depth dₛₗₒₜ of the slot 101e is substantially the same as the thickness d_{carrier} of the carrier 103, and a length lₛₗₒₜ of the slot 101e is also substantially the same as a width w_{carrier} of the carrier 103.

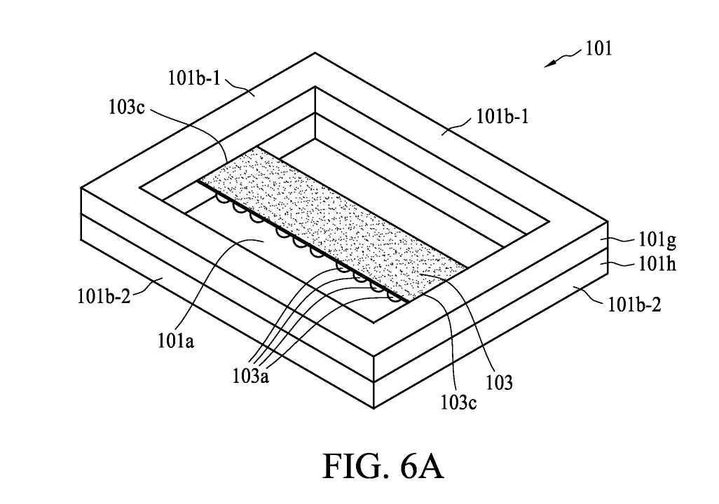

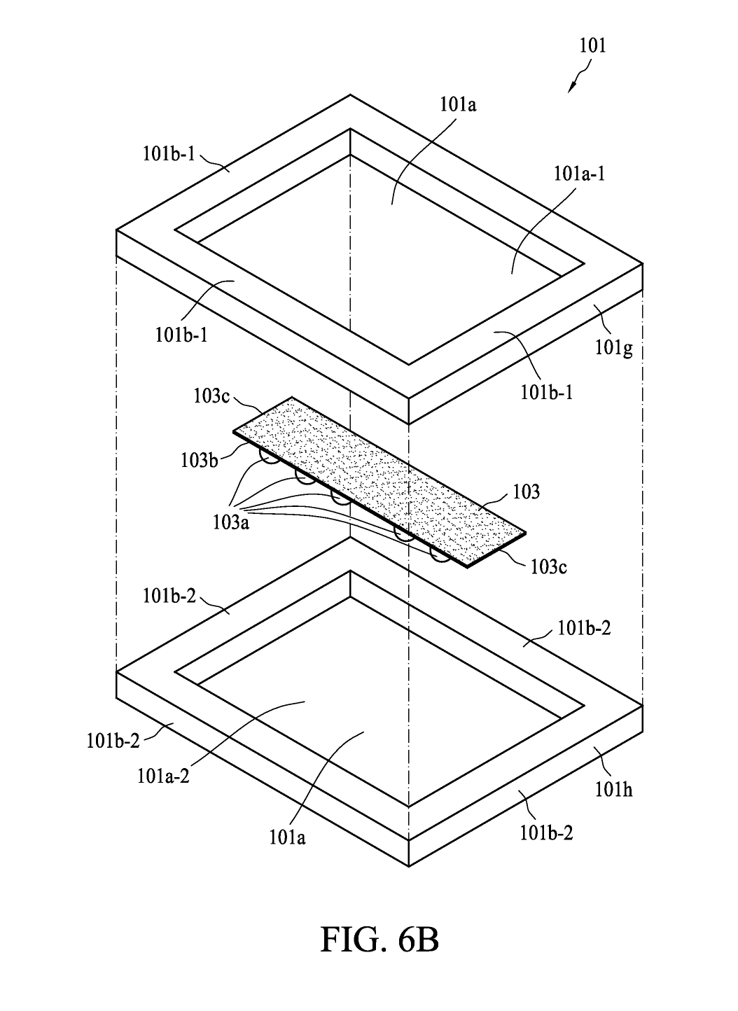

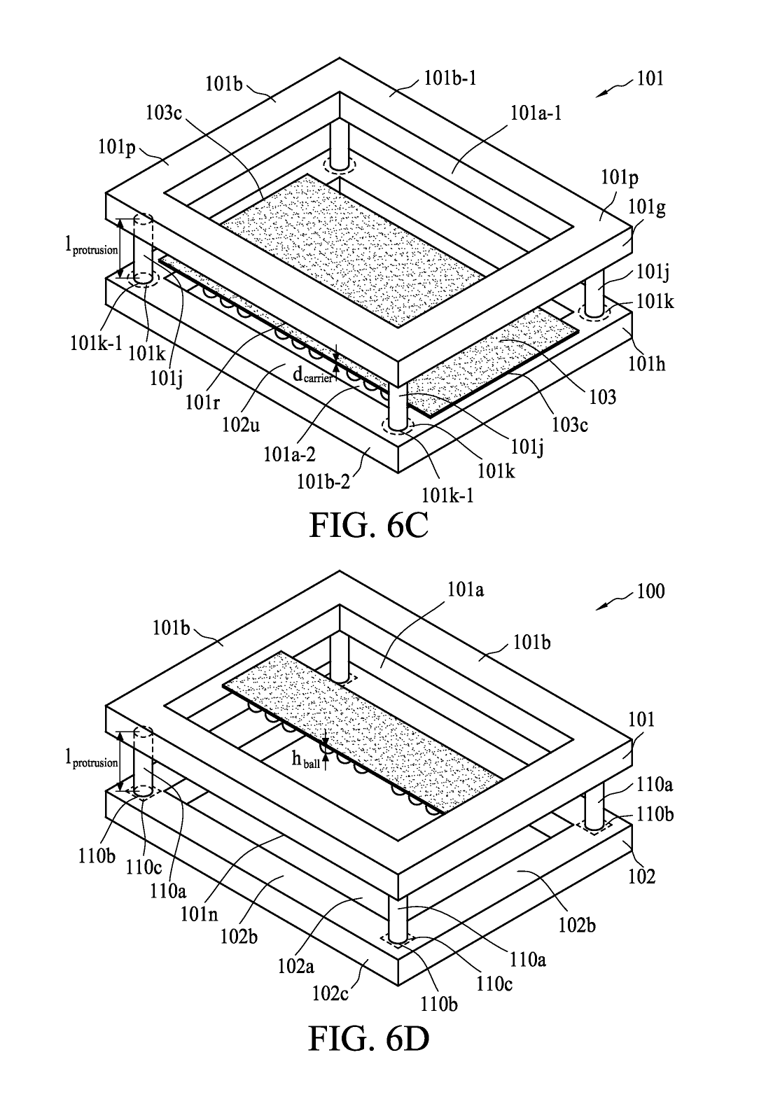

FIG. 6A is an embodiment of a holder 101 including a first clipping member 101g and a second clipping member 101h which are in cooperation for holding a carrier 103. The first clipping member 101g stacks on top of the second clipping member 101h, and the carrier 103 is clipped and securely held between the first clipping member 101g and the second clipping member 101h. As in FIG. 6B, the first clipping member 101g includes a through hole 101a-1 and one or more strips 101b-1, and the second clipping member 101h includes a through hole 101a-2 and one or more strips 101b-2. The first clipping member 101g and the second clipping member 101h are respectively configured in a closed loop by the strips 101b-1 and the strips 101b-2. In some embodiments, the first clipping member 101g is shaped and sized substantially the same as the second clipping member 101h.

As in FIG. 6B, the carrier 103 is secured by disposing a periphery 103c of the carrier 103 between the first clipping member 101g and the second clipping member 101h. A periphery 103c of the carrier 103 is pressed by a cooperation of the first clipping member 101g and the second clipping member 101h. A number of balls 103a mounted on a surface 103b of the carrier 103 are received by a through hole 101a of the holder 101 and passed through from a through hole 101a-1 of the first clipping member 101g to a through hole 101a-2 of the second clipping member 101h.

FIG. 6C is an embodiment of a holder 101 including a first interconnection structure (101j, 101k) for coupling a first clipping member 101g with a second clipping member 101h and thus clipping and securely holding a carrier 103. The first clipping member 101g is detachably coupled with the second clipping member 101h by the first interconnection structure (101j, 101k). The first interconnection structure (101j, 101k) is disposed on a strip 101b adjacent to a periphery 101p of the holder 101.

In some embodiments, the first clipping member 101g couples with the second clipping member 101h in various manner. The first clipping member 101g couples with the second clipping member 101h by magnetism, or the first clipping member 101g is pulled against the second clipping member 101h by vacuum.

In some embodiments, the first clipping member 101g couples with the second clipping member 101h by the first interconnection structure (101j, 101k) in various manner. In some embodiments, the first interconnection structure (101j, 101k) includes a number of protrusions 101j on a first clipping member 101g and a number of receptacles 101k on a second clipping member 101h. Each protrusion 101j corresponds to one of the receptacles 101k. In some embodiments, the protrusion 101j is extended from a bottom surface 101r of the first clipping member 101g towards the receptacle 101k of the second clipping member 101h.

The first clipping member 101g couples with the second clipping member 101h by the protrusion 101j and the receptacle 101k in various manner. In some embodiments, the protrusion 101j is snapped into the receptacle 101k to couple the first clipping member 101g with the second clipping member 101h. In some embodiments, the protrusion 101j is inserted into the receptacle 101k to press a periphery 103c of the carrier 103 and thus to secure the carrier 103 between the first clipping member 101g and the second clipping member 101h.

In some embodiments, the protrusion 101j is in cylindrical shape as in FIG. 6C. In some embodiments, the receptacle 101k is a cavity in circular shape as in FIG. 6C. In some embodiments, an interface of 101k-1 between the protrusion 101j and the receptacle 101k has substantially the same shape and size as the receptacle 101k, so that the protrusion 101j is fittingly accommodated by the receptacle 101k.

In some embodiments as in FIG. 6C, a length lₚᵣₒₜᵣᵤₛᵢₒₙ of the protrusion 101j is substantially equal to the thickness d_{carrier} of the carrier 103. The length lₚᵣₒₜᵣᵤₛᵢₒₙ is a distance between the bottom surface 101r of the first clipping member 101g and a top surface 102u of the second clipping member 101h when the holder 101 is in a closed configuration that the first clipping member 101g is coupled with the second clipping member 101h. In some embodiments, the length lₚᵣₒₜᵣᵤₛᵢₒₙ of the protrusion 101j is slightly greater than the thickness d_{carrier} of the carrier 103.

FIG. 6D is an embodiment of an apparatus 100 including a second interconnection structure (110a, 110b) for coupling a holder 101 with a supporting base 102 and thus securing the holder 101 on the supporting base 102. The holder 101 is detachably coupled with the supporting base 102 by the second interconnection structure (110a, 110b). The second interconnection structure (110a, 110b) is disposed on a strip 101b of the holder 101 and a periphery 102b of the supporting base 102.

The holder 101 couples with the supporting base 102 in various manner. In some embodiments, the second interconnection structure (110a, 110b) includes a number of projections 110a on a bottom surface 101n of the holder 101 and a number of indentations 110b on a periphery 102b of the supporting base 102. Each projections 110a corresponds to one of the indentations 110b. In some embodiments, the projection 110a is extended from the bottom surface 101n of the holder 101 towards the indentation 110b of the supporting base 102.

In some embodiments, the projection 110a is in cylindrical shape as in FIG. 6D. In some embodiments, the indentation 110b is a cavity in circular shape as in FIG. 6D. In some embodiments, an interface of 110c between the projection 110a and the indentation 110b has substantially the same shape and size as the indentation 110b, so that the projection 110a is fittingly accommodated by the indentation 110b.

In some embodiments, the holder 101 is coupled and held on the supporting base 102 by magnetism along the strips 101b of the holder and the periphery 102b of the supporting base, or the holder 101 is pulled against the periphery 102b of the supporting base 102 by vacuum.

In some embodiments as in FIG. 6D, a length l_{projection} of the projection 110a is substantially equal to a ball height h_{ball} of the balls 103a on the carrier 103. The length l_{projection} is a distance between the bottom surface 101n of the holder 101 and a top surface 102c of the supporting base 102 when the apparatus 100 is in a closed configuration that the holder 101 is coupled with the supporting base 102. In some embodiments, the length l_{projection} of the projection 110a is slightly greater than the ball height h_{ball} of the balls 103a on the carrier 103.

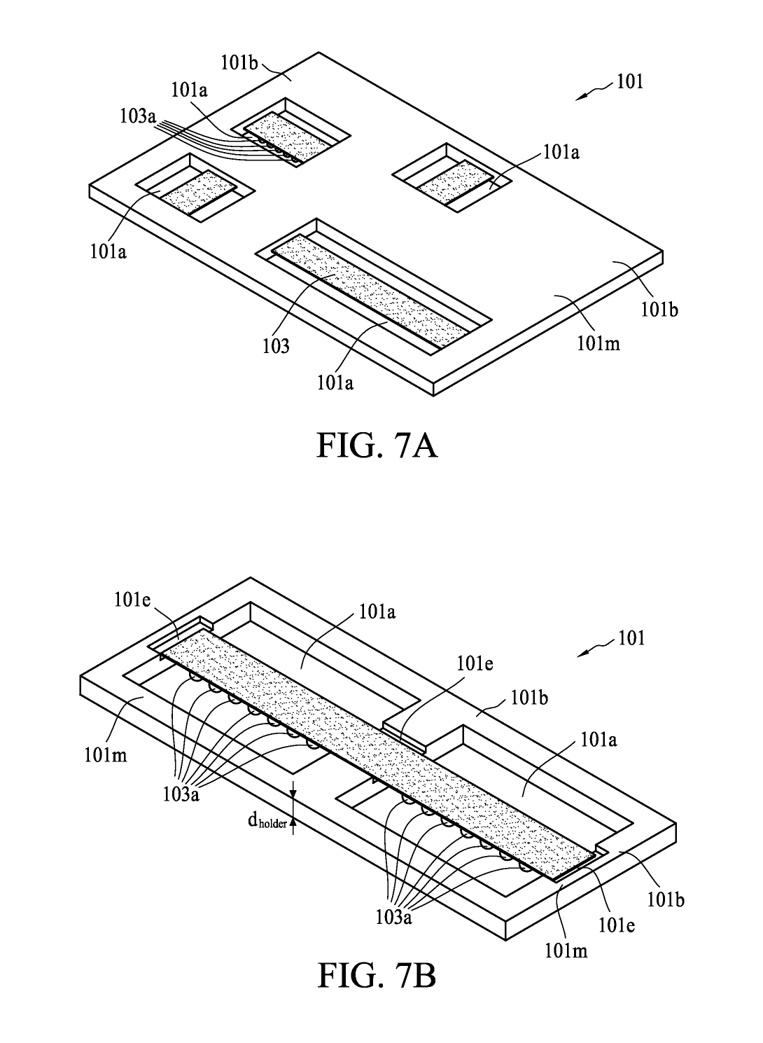

FIG. 7A is an embodiment of a holder 101 in a mesh configuration. The holder 101 includes a number of through holes 101a. Each through hole 101a is surrounded by one or more strips 101b and is configured for receiving and holding a carrier 103. The through hole 101a extends from a top surface 101m of the holder 101. A number of balls 103a on the carrier 103 pass through the through hole 101a.

In some embodiments, the holder 101 in a mesh configuration includes a number of through holes 101a and a number of slots 101e as in FIG. 7B. The slot 101e is configured for holding a carrier 103. The slot 101e is indented from a top surface 101m of the holder 101 along a depth d_{holder} of the holder 101. In some embodiments, the through holes 101a are surrounded by the strips 101b and are aligned with each other along a direction. The through holes 101a are aligned longitudinally as in FIG. 7B. In some embodiments, the carrier 103 is in a continuous strip form and is across over the slots 101e and is held within the slots 101e, so a number of balls 103a on the carrier 103 pass through the through holes 101a as in FIG. 7b.

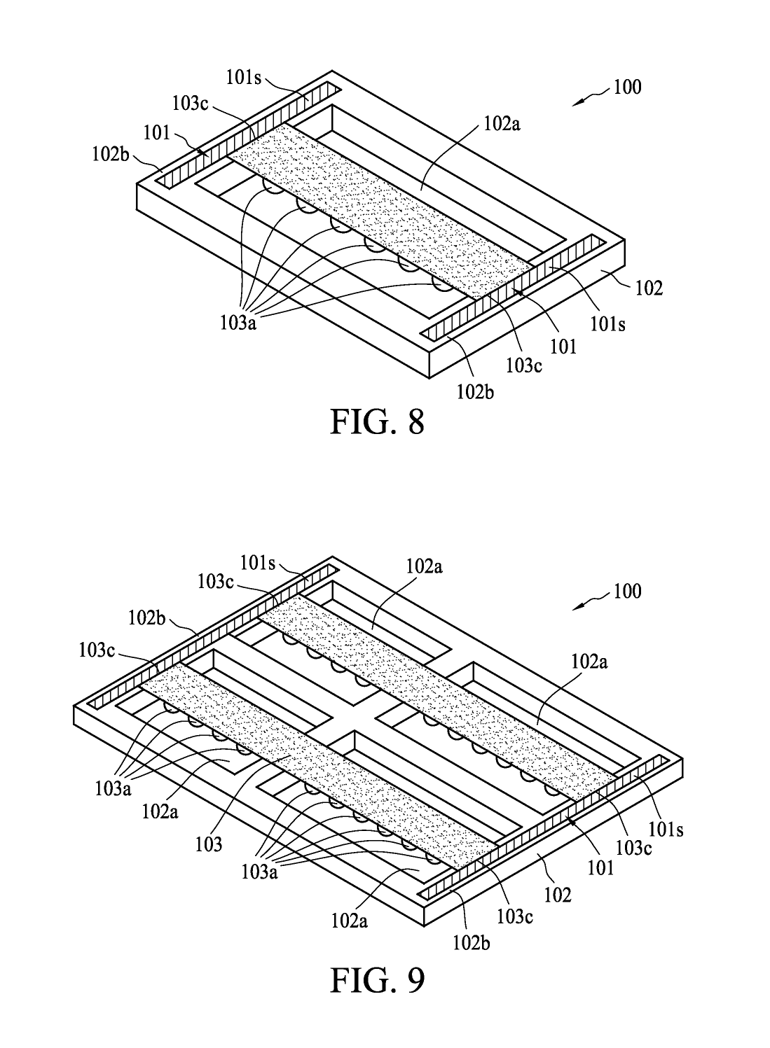

FIG. 8 is an embodiment of an apparatus 100 for manufacturing a semiconductor package. The apparatus 100 includes a holder 101 for holding a carrier 103 and a supporting base 102 for accommodating a number of balls 103a on a surface 103b of the carrier 103. In some embodiments, the holder 101 includes a number of elongated pieces 101s for pressing and holding a periphery 103c of the carrier 103. The elongated piece 101s is disposed and supported on a periphery 102b of the supporting base 102. The periphery 103c of the carrier 103 is pressed on the supporting base 102 by the elongated pieces 101s, so that the carrier 103 is held between the holder 101 and the supporting base 102. In some embodiments, the holder 101 includes a pair of elongated pieces 101s which are in cooperation to hold the carrier 103 horizontally on the periphery 102b of the supporting base 102. In some embodiments, the pair of the elongated pieces 101s are configured such that the carrier 103 does not have any warpage, without curving into or out of the recess 102a.

In some embodiments, the supporting base 102 includes a recess 102a which is configured for accommodating the number of balls 103a on a carrier 103 as in FIG. 8. The recess 102a is surrounded by a periphery 102b of the supporting base 102. When the periphery 103c of the carrier 103 is disposed and pressed on the periphery 102b of the supporting base 102 by the holder 101, the balls 103a are seated within the recess 102a.

FIG. 9 is an embodiment of an apparatus 100 including a supporting base 102 in a mesh configuration. The supporting base 102 includes a number of recesses 102a which are aligned with each other in a direction. In some embodiments, the recesses 102a are aligned vertically and horizontally as in FIG. 9. Each of the recesses 102a accommodates a number of balls 103a on a carrier 103. In some embodiments, the supporting base 102 receives and supports one or more carriers 103 in a strip shape. The carriers 103 is held by a pair of elongated pieces 101s of a holder 101 disposed on a periphery 102b of the supporting base 102. In some embodiments, the balls 103a are specifically arranged in accordance with a shape and size of the recess 102a, so that the balls 103a are accommodated by the recess 102a.

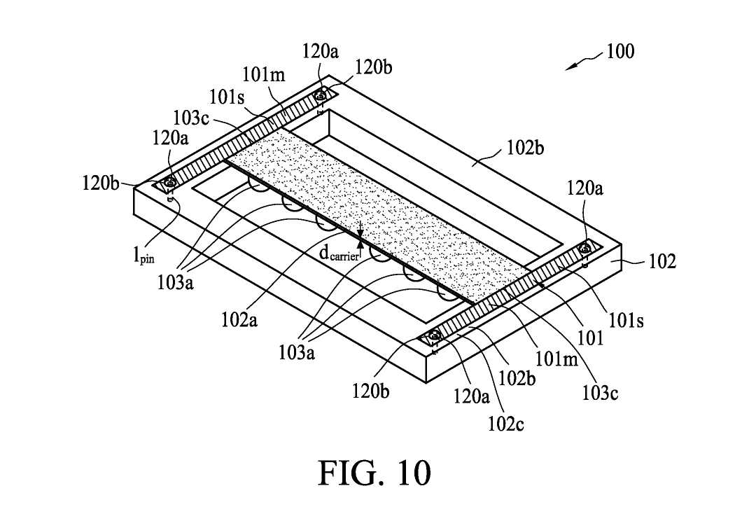

FIG. 10 is an embodiment of an apparatus 100 including a third interconnection structure (120a, 120b) for coupling a number of elongated pieces 101s of a holder 101 with a supporting base 102 and thus securely holding the carrier 103 between the elongated piece 101s and the supporting base 102. The elongated piece 101s is detachably coupled with the supporting base 102 by the third interconnection structure (120a, 120b). In some embodiments, the third interconnection structure (120a, 120b) including a pin 120a and an aperture 120b. The pin 120a passes through the aperture 120b extending from a top surface 101m of the elongated piece 101s of the holder 101 to a top surface 102c of the supporting base 102, so that the elongated piece 101s is pressed on a periphery 103c of the carrier 103 and a periphery 102b of the supporting base 102.

In some embodiments, a length lₚᵢₙ of the pin 120a is substantially equal to the thickness d_{carrier} of the carrier 103. The length lₚᵢₙ is a distance between a top surface 101m of the elongated piece 101s and a top surface 102c of the supporting base 102. In some embodiments, the length lₚᵢₙ of the pin 120a is slightly greater than the thickness d_{carrier} of the carrier 103.

In the present disclosure, a method of manufacturing a semiconductor device is also disclosed. In some embodiments, a semiconductor device is formed by a method 200. The method 200 includes a number of operations and the description and illustration are not deemed as a limitation as the sequence of the operations.

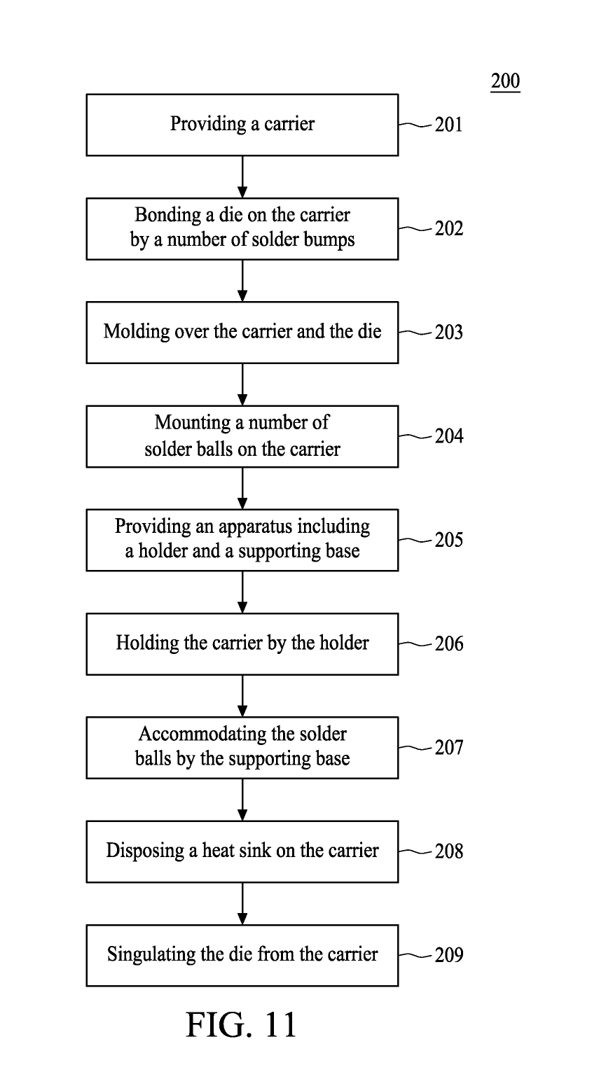

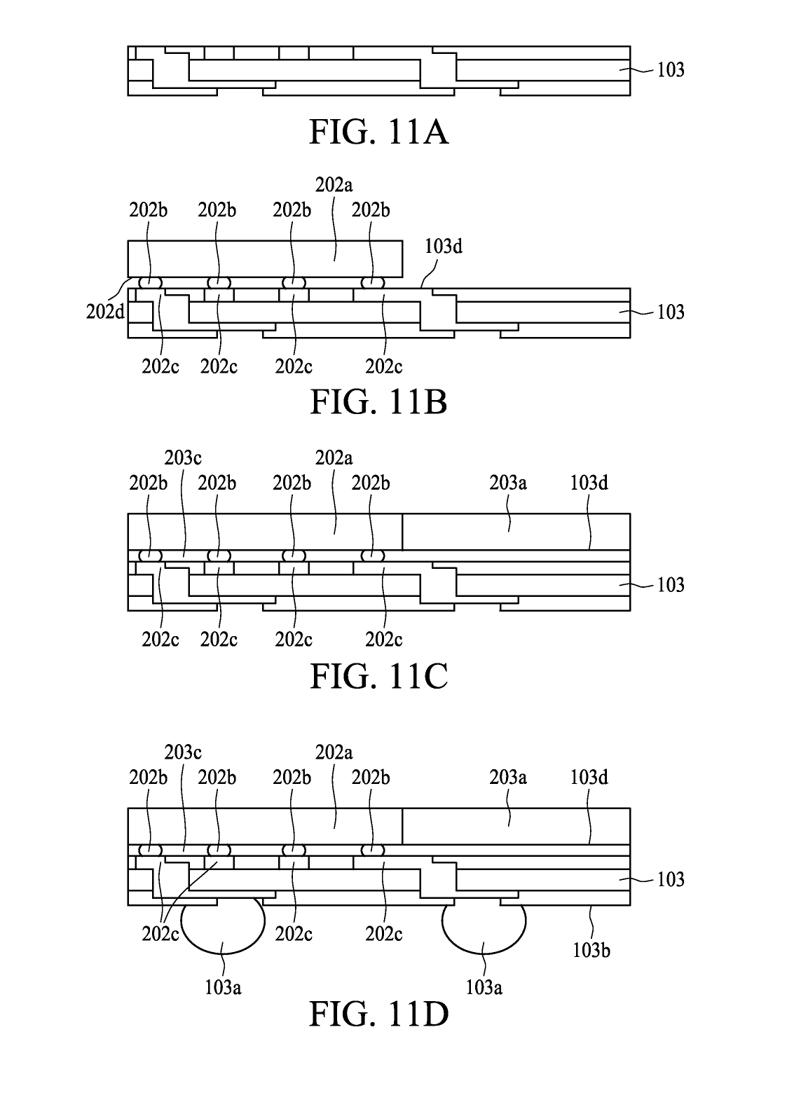

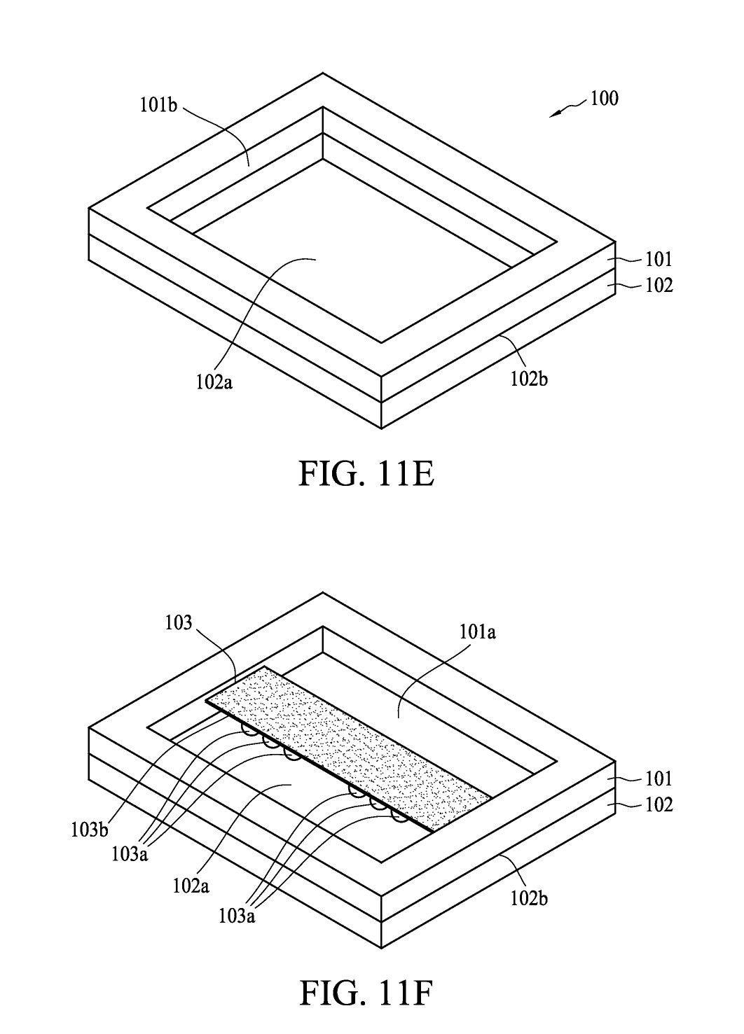

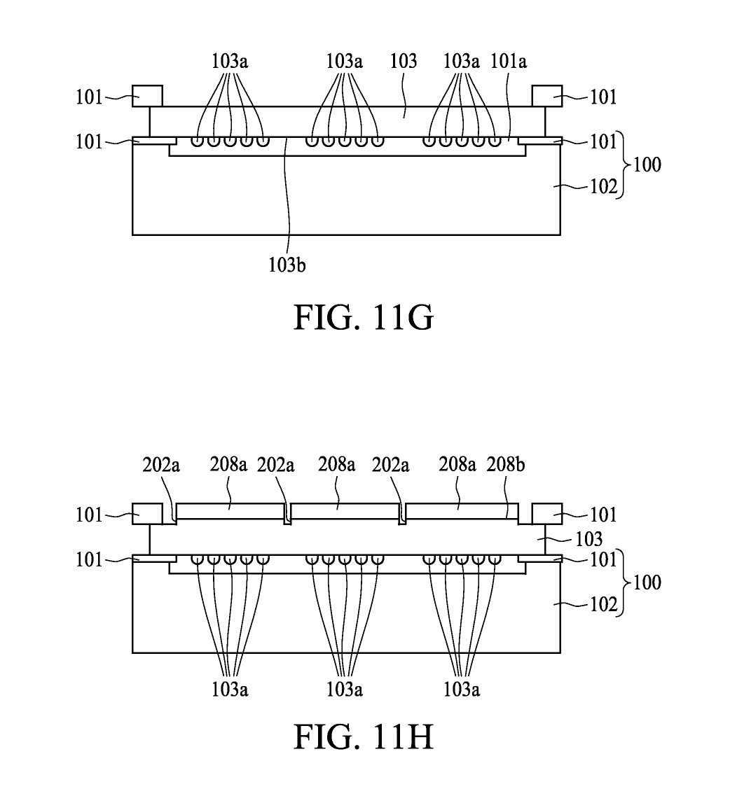

FIG. 11 is an embodiment of a method 200 of manufacturing a semiconductor device. The method 200 includes operations 201, 202, 203, 204, 205, 206, 207, 208, 209. In operation 201, a carrier 103 is provided as in FIG. 11A. In some embodiments, the carrier 103 is a substrate or interposer which includes a number of layers for carrying components and integrated circuits (IC) within the layers. The substrate or interposer is produced from crystal form of silicon or polymer through numbers of operations such as fabrication, etching or photolithography, etc.

In operation 202, a die 202a is bonded on the carrier 103 as in FIG. 11B. In some embodiments, the die 202a is a flip chip die 202a including a bottom surface 202d mounted on the carrier 103. In some embodiments, the flip chip die 202a is bonded on the carrier 103 by a number of solder bumps 202b. In some embodiments, the flip chip die 202a is bonded on the carrier 103 by a number of flip chip solder bumps. In some embodiments, there are a number of pads 202c formed on a top surface 103d of the carrier 103. The pads 202c are configured for receiving flip chip solder bumps 202b, so that the flip chip die 202a is mounted on the carrier 103 as in FIG. 11B.

In operation 203, the carrier 103 and the flip chip solder bumps 202b are covered by a molding 203a as in FIG. 11C. The molding 203a covers a substantial top surface 103d of the carrier 103 and fills up a space 203c between flip chip die 202a, flip chip solder bumps 202b and carrier 103 in order to protect electrical interconnections between carrier 103 and flip chip solder bumps 202b.

In some embodiments, the molding 203a includes a molding compound including composite materials consisted of epoxy resin, silica, or etc. In some embodiments, the space 203c between the flip chip die 202a and the flip chip solder bumps 202b are filled by an underfill which includes an electrically non-conductive material.

In operation 204, a number of solder balls 103a are mounted on a bottom surface 103b of the carrier 103 as in FIG. 11D. The solder balls 103a are respectively attached on a number of ball pads 204a on the bottom surface 103b of the carrier 103. In some embodiments, the ball pad 204a is a solderable surface which is exposed part of a circuit of the carrier 103. In some embodiments, the ball pad 204a is served as a platform for receiving the solder ball 103a and connecting the circuit of the carrier 103 with a circuit of the flip chip die 202a. The solder ball 103a is attached and bonded on the ball pad 204a after a heat treatment such as reflow or etc.

In operation 205, an apparatus 100 is provided for holding the carrier 103 as in FIG. 11E. The apparatus 100 is formed including a holder 101 for holding the carrier 103 and a supporting base 102 for receiving the holder 101. The holder 101 is covered on top of the supporting base 102. In some embodiments, the holder 101 is supported on the supporting base 102 by a periphery 102b of the supporting base 102. In some embodiments, the holder 101 is formed in a similar profile and dimension as the supporting base 102, so that the holder 101 stacks on the supporting base 102. In some embodiments, the apparatus 100 is made of a metal or metal alloy with a high melting point, for example silicon carbide or etc.

In operation 206, the carrier 103 is held by the holder 101 of the apparatus 100 as in FIG. 11F. The carrier 103 is held within a through hole 101a of the holder 101 and a recess 102a of the supporting base 102. In some embodiments, the through hole 101a is formed in a central part of the holder 101 for receiving and holding the carrier 103. In some embodiments, a substantial area of the carrier 103 is held within the through hole 101a as in FIG. 11F. In some embodiments, the carrier 103 is securely held by the holder 101 in various manner such as clipping between two clipping members, pressing by a number of elongated pieces, accommodating within slots or slits, pressing by magnetism or vacuum, or etc.

In operation 207, the solder balls 103a on the carrier 103 are accommodated by the supporting base 102 as in FIG. 11G. The solder balls 103a pass through the through hole 101a of the holder 101 and seat within the recess 102a of the supporting base 102. In some embodiments, the recess 102a is formed adjacent to a central part of the supporting base 102 to receive and accommodate the solder balls 103a mounted on the bottom surface 103b of the carrier 103. The solder balls 103a are hanged within the recess 102a as in FIG. 11G in order to prevent the solder balls 103a from collision and damages. In some embodiments, the recess 102a of the supporting base 102 is substantially overlapped with the through hole 101a of the holder 101.

In operation 208, a heat sink 208a is disposed on top of the flip chip die 202a when the carrier 103 is held by the apparatus 100 including the holder 101 and the supporting base 102. In some embodiment, the heat sink 208a is attached and covered on a top surface 208b of the flip chip die 202a on the carrier 103. The heat sink 208a is configured for dissipating a heat from the die 202a to the surrounding. In some embodiments, the heat sink 208a is made of a metal such as aluminum or a metal alloy or etc.

In operation 209, the flip chip die 202a is singulated from the carrier 103. The flip chip die 202a is saw out from the carrier 103 by a mechanical saw to become a semiconductor package such as flip chip chip scale package (FCCSP), which would be dispatched out or transported for subsequent operations.

In some embodiments, an apparatus for manufacturing a semiconductor package, including a holder for holding a carrier and a supporting base for receiving the holder including a recess for accommodating a plurality of balls mounted on a surface of the carrier. The holder is disposed and supported on the supporting base by a periphery of the supporting base. The holder includes a first clipping member and a second clipping member which are in cooperation for holding the carrier.

In some embodiments, the holder includes a first interconnection structure for coupling the first clipping member with the second clipping member. The first interconnection structure includes a protrusion on the first clipping member and a receptacle on the second clipping member for receiving the protrusion. The apparatus further includes a second interconnection structure for coupling the holder and the supporting base. The second interconnection structure includes a projection on the holder and an indentation on the supporting base for receiving the projection.

In some embodiments, the holder is in a mesh configuration. The supporting base is in a mesh configuration. The supporting base includes aluminum. The carrier is in a strip shape.

In some embodiments, an apparatus for manufacturing a semiconductor package, including a supporting base includes a periphery and a recess. The periphery is configured for securely holding a carrier on the supporting base, and the recess is configured for accommodating a plurality of balls mounted on a surface of the carrier. The recess is substantially surrounded by the periphery. The periphery is configured for securing the carrier on the supporting base by magnetism. The periphery is configured for securing the carrier on the supporting base by vacuum.

In some embodiments, a method of manufacturing a semiconductor package, including providing a carrier, providing an apparatus including a supporting base including a recess, holding the carrier on the supporting base and accommodating a plurality of balls mounted on a surface of the carrier in the recess. The method further includes disposing a heat sink over the carrier upon holding the carrier by the apparatus. The method further includes holding the carrier on a periphery of the supporting base by magnetism. The method further includes providing the apparatus including a holder and securely holding a carrier within the holder by a first interconnection structure. The method further includes securely disposing the holder on the supporting base by a second interconnection structure.

The methods and features of this invention have been sufficiently described in the above examples and descriptions. It should be understood that any modifications or changes without departing from the spirit of the invention are intended to be covered in the protection scope of the invention.

Moreover, the scope of the present application in not intended to be limited to the particular embodiments of the process, machine, manufacture, and composition of matter, means, methods and steps described in the specification. As those skilled in the art will readily appreciate from the disclosure of the present disclosure, processes, machines, manufacture, composition of matter, means, methods or steps presently existing or later to be developed, that perform substantially the same function or achieve substantially the same result as the corresponding embodiments described herein maybe utilized according to the present disclosure.

Accordingly, the appended claims are intended to include within their scope such as processes, machines, manufacture, compositions of matter, means, methods or steps. In addition, each claim constitutes a separate embodiment, and the combination of various claims and embodiments are within the scope of the invention.

1. An apparatus for manufacturing a semiconductor device, comprising:
a holder for holding a carrier; and
a supporting base for receiving the holder comprising a recess for accommodating a plurality of balls mounted on a surface of the carrier.

2. The apparatus of claim 1, wherein the holder is disposed and supported on the supporting base by a periphery of the supporting base.

3. The apparatus of claim 1, wherein the holder comprises a first clipping member and a second clipping member which are in cooperation for holding the carrier.

4. The apparatus of claim 3, wherein the holder comprises a first interconnection structure for coupling the first clipping member with the second clipping member.

5. The apparatus of claim 4, wherein the first interconnection structure comprises a protrusion on the first clipping member and a receptacle on the second clipping member for receiving the protrusion.

6. The apparatus of claim 1, further comprising a second interconnection structure for coupling the holder and the supporting base.

7. The apparatus of claim 6, wherein the second interconnection structure comprises a projection on the holder and an indentation on the supporting base for receiving the projection.

8. The apparatus of claim 1, wherein the holder is in a mesh configuration.

9. The apparatus of claim 1, wherein the supporting base is in a mesh configuration.

10. The apparatus of claim 1, wherein the supporting base includes aluminum.

11. The apparatus of claim 1, wherein the carrier is in a strip shape.

12. An apparatus for manufacturing a semiconductor device, comprising:
a supporting base comprises a periphery and a recess;
wherein the periphery is configured for securely holding a carrier on the supporting base, and the recess is configured for accommodating a plurality of balls 103a mounted on a surface of the carrier.

13. The apparatus of claim 12, wherein the recess is substantially surrounded by the periphery.

14. The apparatus of claim 12, wherein the periphery is configured for securing the carrier on the supporting base by magnetism.

15. The apparatus of claim 12, wherein the periphery is configured for securing the carrier on the supporting base by vacuum.

16. A method of manufacturing a semiconductor device, comprising:
providing a carrier;
providing an apparatus comprising a supporting base including a recess;
holding the carrier on the supporting base; and
accommodating a plurality of balls mounted on a surface of the carrier in the recess.

17. The method of claim 16, further comprising disposing a heat sink over the carrier upon holding the carrier by the apparatus.

18. The method of claim 16, further comprising holding the carrier on a periphery of the supporting base by magnetism.

19. The method of claim 16, further comprising providing the apparatus comprising a holder and securely holding a carrier within the holder by a first interconnection structure.

20. The method of claim 19, further comprising securely disposing the holder on the supporting base by a second interconnection structure.
